(19) United States
(12) Patent Application Publication
(10) Pub. No.: US 2010/0181856 A1
(43) Pub. Date: Jul. 22, 2010

(54) MAGNETICALLY DRIVING DEVICE

(76) Inventor: Ruei-Jen Chen, Taoyuan City (TW)

Correspondence Address: KIRTON AND MCCONKIE, 60 EAST SOUTH TEMPLE,, SUITE 1800, SALT LAKE CITY, UT, 84111, US

(21) Appl. No.: 12/357,566

(22) Filed: Jan. 22, 2009

(51) Int. Cl. H02K 21/00; H02N 11/00

(52) U.S. Cl. 310/154.01; 310/156.01; 415/916

(57) ABSTRACT

A magnetically driving device includes a first supporting member, a second supporting member, a first magnet set and a second magnet set. The second supporting member is movable with respect to the first supporting member. The first magnet set includes at least one first magnet unit. The first magnet unit has a first magnetic pole and a second magnetic pole of different polarities. The second magnet set includes at least one second magnet unit. The second magnet unit has a first magnetic pole and a second magnetic pole of different polarities. The magnetization directions of the first magnetic poles of the first magnet unit and the second magnet unit are not parallel with each other, so that a magnetic force generated between the first magnet unit and the second magnet unit drives movement of the second supporting member with respect to the first supporting member.

### FIELD OF THE INVENTION

The present invention relates to a magnetically driving device, and more particularly to a magnetically driving device for use as a motive power source or an energy source of a driven device.

### BACKGROUND OF THE INVENTION

A power-generating device is widely used to generate input energy for driving a driven device such as an electrical appliance. For example, the electric energy generated by a nuclear power facility, a thermal power facility or fossil fuels is used to drive transportation system or household electrical appliances. The use of the conventional power source, however, leads to ecological problems and wastes resource.

Consequently, there are growing demands on clean energy. Among various alternative energy sources, solar energy, wind power and bio-energy are expected to replace fossil fuel or nuclear energy as new energy sources. There alternative energy sources, however, still have respective restrictions. For example, the solar power plants need to be situated at the very sunny places; and the wind power plants need to be situated at the very windy places.

Therefore, there is a need of providing a magnetically driving device to obviate the drawbacks encountered from the prior art.

### SUMMARY OF THE INVENTION

It is an object of the present invention to provide a magnetically driving device for use as a motive power source or an energy source of a driven device.

Another object of the present invention provides a magnetically driving device for generating motive power or electric energy without resulting in ecological problems.

In accordance with an aspect of the present invention, there is provided a magnetically driving device. The magnetically driving device includes a first supporting member, a second supporting member, a first magnet set and a second magnet set. The second supporting member is disposed beside the first supporting member and movable with respect to the first supporting member. The first magnet set is fixed on the first supporting member and includes at least one first magnet unit. The first magnet unit has a first magnetic pole and a second magnetic pole of different polarities. The second magnet set is fixed on the second supporting member and includes at least one second magnet unit. The second magnet unit has a first magnetic pole and a second magnetic pole of different polarities. The magnetization direction of the first magnetic pole of the first magnet unit and the magnetization direction of the first magnetic pole of the second magnet unit are not parallel with each other, so that a magnetic force generated between the first magnet unit and the second magnet unit drives movement of the second supporting member with respect to the first supporting member.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a magnetically driving device according to a preferred embodiment of the present invention;

FIG. 2 is a schematic perspective view of the magnetically driving device shown in FIG. 1;

FIG. 3 is a schematic perspective view illustrating the use of the magnetically driving device of the present invention to generate electric energy;

FIGS. 4A and 4B schematically illustrate two variants of the arrangement of the first magnet units of the magnetically driving device shown in FIG. 2; and

FIG. 5 is a schematic view illustrating a magnetically driving device according to a second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

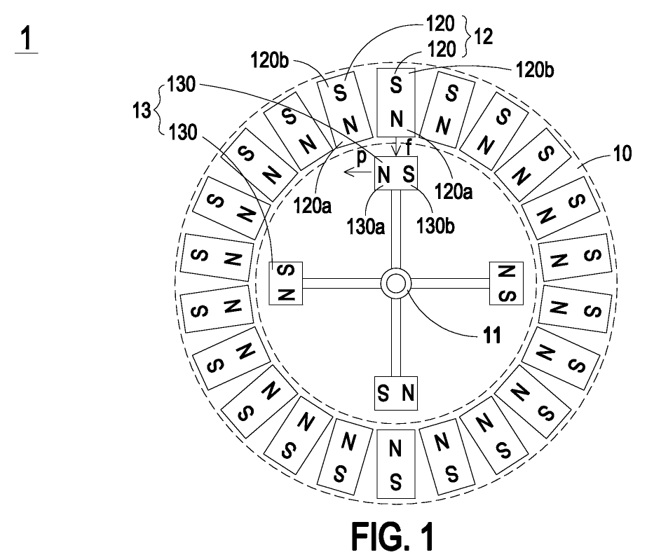

FIG. 1 is a schematic view illustrating a magnetically driving device according to a first preferred embodiment of the present invention. As shown in FIG. 1, the magnetically driving device 1 principally comprises a first supporting member 10, a second supporting member 11, a first magnet set 12 and a second magnet set 13. The second supporting member 11 is circumferentially enclosed by the first supporting member 10. The first magnet set 12 is fixed on the first supporting member 10. The first magnet set 12 comprises one or more first magnet units 120. Each first magnet unit 120 of the first magnet set 12 includes a first magnetic pole 120a and a second magnetic pole 120b. The first magnetic pole 120a and the second magnetic pole 120b of the first magnet unit 120 have different polarities. The second magnet set 13 is fixed on the second supporting member 11. The second magnet set 13 comprises one or more second magnet units 130. Each second magnet unit 130 of the second magnet set 13 includes a first magnetic pole 130a and a second magnetic pole 130b. The first magnetic pole 130a and the second magnetic pole 130b of the second magnet unit 130 have different polarities. The magnetization direction p of the first magnetic pole 130a of the second magnet unit 130 is not parallel with the magnetization direction f of the first magnetic pole 120a of the first magnet unit 120. Since like poles repel each other and unlike poles attract each other, the attractive or repulsive force generated between the second magnet units 130 and the first magnet units 120 will drive movement or rotation of the second supporting member 11 with respect to the first supporting member 10.

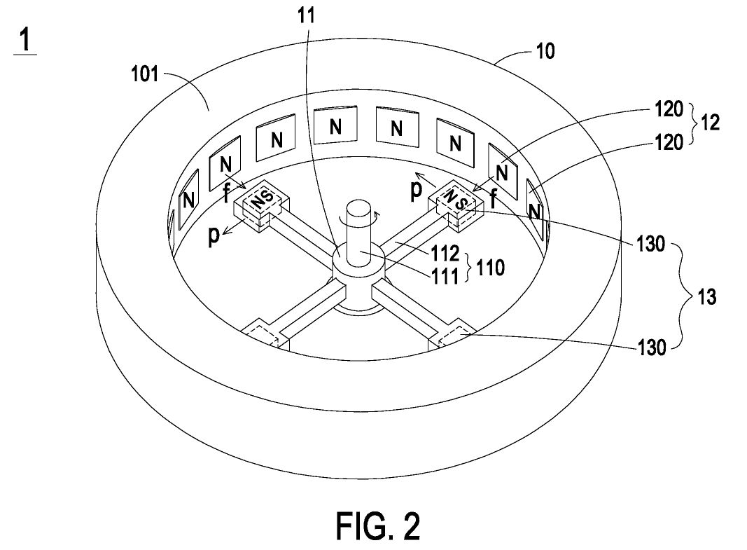

FIG. 2 is a schematic perspective view of the magnetically driving device shown in FIG. 1. As shown in FIG. 2, the first magnet set 12 comprises multiple first magnet units 120. These first magnet units 120 are connected with or separated from each other as long as the first magnetic poles 120a of the first magnet units 120 are arranged at the same side of the first magnet set 12. The first magnet units 120 are embedded into the first supporting member 10. In this embodiment, the first supporting member 10 is an annular plastic article or structured element. The first magnet units 120 are circumferentially arranged on the first supporting member 10 so as to collectively define an annular region 101. Due to the configuration of the first supporting member 10, the first magnet units 120 are stationary. The second magnet set 13 comprises multiple second magnet units 130. The second magnet units 130 are fixed on the second supporting member 11. The second supporting member 11 comprises a rotary member 110 including a shaft portion 111 and at least one rotating arm 112. The rotary member 110 is enclosed by the annular region 101 of the first supporting member 10. The centerline of the shaft portion 111 of the second supporting member 11 and the centerline of the annular region 101 of the first supporting member 10 are superimposed with each other. In this embodiment, the rotary member 110 has multiple rotating arms 112, which are discretely arranged on the periphery of the shaft portion 111 at regular intervals. The second magnet units 130 are arranged on the distal parts of the rotating arm 112, in which the second magnetic pole 130b of the previous second magnet unit 130 and the first magnetic pole 130a of the next second magnet unit 130 are connected with or separated from each other. In addition, the second magnet units 130 are disposed in the vicinity of the annular region 101 of the rotary member 110, so that each second magnet unit 130 is close to at least one of the first magnet units 120.

In some embodiments, the first magnetic poles 120a and the second magnetic poles 120b of the first magnet units 120 are N-poles and S-poles, respectively. The first magnetic poles 120a of the first magnet units 120 are orientated toward the centerline of the annular region 101. The first magnetic poles 120a (i.e. N-poles) of the first magnet units 120 are close to the inner surface of the first supporting member 10. The second magnetic poles 120b of the first magnet units 120 (i.e. S-poles) are close to the outer surface of the first supporting member 10. The first magnetic poles 130a and the second magnetic poles 130b of the second magnet units 130 are N-poles and S-poles, respectively. The second magnet units 130 are arranged on the distal parts of the rotating arm 112, in which the second magnetic pole 130b (i.e. S-pole) of the previous second magnet unit 130 is adjacent to the first magnetic pole 130a (i.e. N-pole) of the next second magnet unit 130. In accordance with a key feature of the present invention, the magnetization direction p of the first magnetic pole 130a of the second magnet unit 130 is not parallel with the magnetization direction f of the first magnetic pole 120a of the first magnet unit 120. For example, the included angle between the magnetization direction p of the first magnetic pole 130a and the magnetization direction f of the first magnetic pole 120a is ranged from 45 to 90 degrees. Since like poles repel each other and unlike poles attract each other, the attractive or repulsive force generated between the second magnet units 130 and the first magnet units 120 will drive movement or rotation of the second supporting member 11 with respect to the first supporting member 10. In other words, when the second magnet units 130 are influenced by the magnetic field (or the magnetic field lines) of one of the first magnet units 120, the second magnet units 130 are moved forward and then influenced by the magnetic field of an adjacent first magnet unit 120. As such, the second magnet units 130 are continuously moved forward and then influenced by the magnetic field of the next first magnet unit 120. As the second magnet units 130 are continuously moved, the shaft portion 111 of the second supporting member 11 is rotated. Upon rotation of the shaft portion 111, the mechanical energy produced by the magnetically driving device is converted into other forms of motive power or energy.

In some embodiments, the first supporting member 10 is a stator and the second supporting member 11 is a rotator. Alternatively, the first supporting member 10 is a rotator and the second supporting member 11 is a stator. In some embodiments, the positions of the first supporting member 10 and the second supporting member 11 are exchanged. That is, the first supporting member 10 is circumferentially enclosed by the second supporting member 11. In some embodiments, a gear set (not shown) is connected to the shaft portion 111 of the second supporting member 11 and the gear set is engaged with a corresponding gear set of a driven device, thereby driving the driven device. In addition, the second magnet units 130 and the first magnet units 120 are coplanar or non-coplanar.

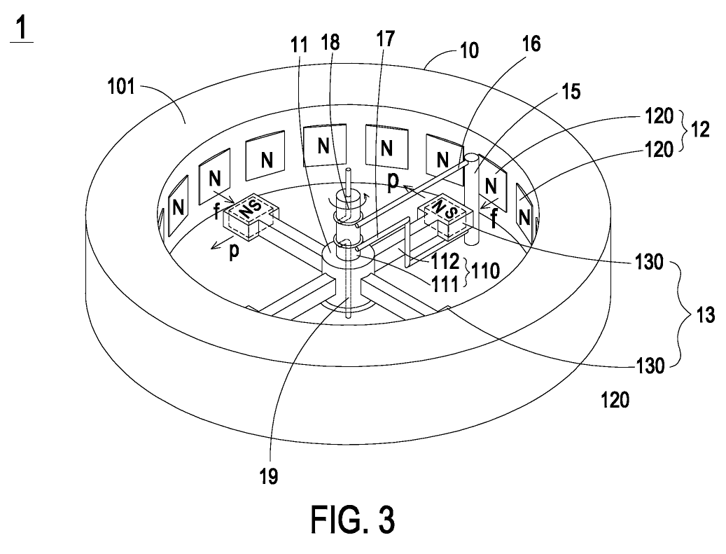

FIG. 3 is a schematic perspective view illustrating the use of the magnetically driving device of the present invention to generate electric energy. In addition to the first supporting member 10, the second supporting member 11, the first magnet set 12 and the second magnet set 13 shown in FIGS. 1 and 2, the magnetically driving device 1 further includes a first conducting wire 15, a first floating connection element 16, a second floating connection element 17, a second conducting wire 18 and a third conducting wire 19. The first conducting wire 15 is disposed on the second supporting member 11. For example, the first conducting wire 15 is disposed on the surface of the second magnet unit 130. In addition, the first conducting wire 15 is arranged between the first magnet set 12 and the second magnet set 13. Both terminals of the first conducting wire 15 are respectively connected to a first terminal of the first floating connection element 16 and a first terminal of the second floating connection element 17. A second terminal of the first floating connection element 16 and a second terminal of the second floating connection element 17 are respectively connected to the second conducting wire 18 and the third conducting wire 19 in a floating connection manner. The second conducting wire 18 and the third conducting wire 19 are fixed onto the shaft portion 111 of the second supporting member 11. As such, the second terminal of the first floating connection element 16 and a second terminal of the second floating connection element 17 are continuously and always contacted with the second conducting wire 18 and the third conducting wire 19. Under this circumstance, the second conducting wire 18 and the third conducting wire 19 will not be entangled on the shaft portion 111 of the second supporting member 11. In this embodiment, the first floating connection element 16 and the second floating connection element 17 are carbon brushes. Since the second supporting member 11 is movable with respect to the first supporting member 10, the first conducting wire 15 will cut through the magnetic field (or the magnetic field lines) of the first magnet unit 120 to generate a current in the first conducting wire 15. The current will be transmitted out of the magnetically driving device 1 through the first floating connection element 16, the second floating connection element 17, the second conducting wire 18 and the third conducting wire 19. As such, the current is used in any electrical appliance.

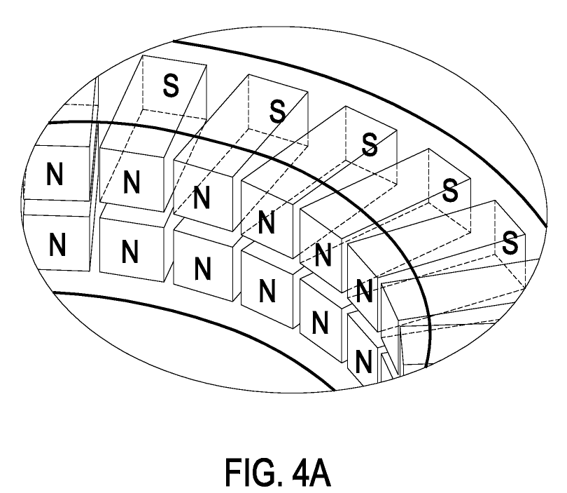

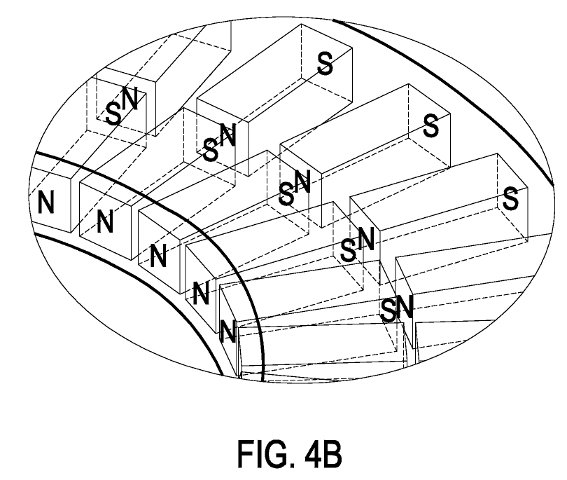

FIGS. 4A and 4B schematically illustrate two variants of the arrangement of the first magnet units of the magnetically driving device shown in FIG. 2. As shown in FIG. 4A, the first magnet units 120 of the first magnet set 12 are arranged in a stack. As shown in FIG. 4B, the first magnet units 120 of the first magnet set 12 are arranged in an array. In the array of the first magnet units 120, the second magnetic poles 120b (e.g. S-poles) of the first magnet units 120 at the front row and the first magnetic poles 120a (e.g. N-poles) of the first magnet units 120 at the back row are connected with or separated from each other. Similarly, the second magnet units 130 can be arranged in a stack or in an array.

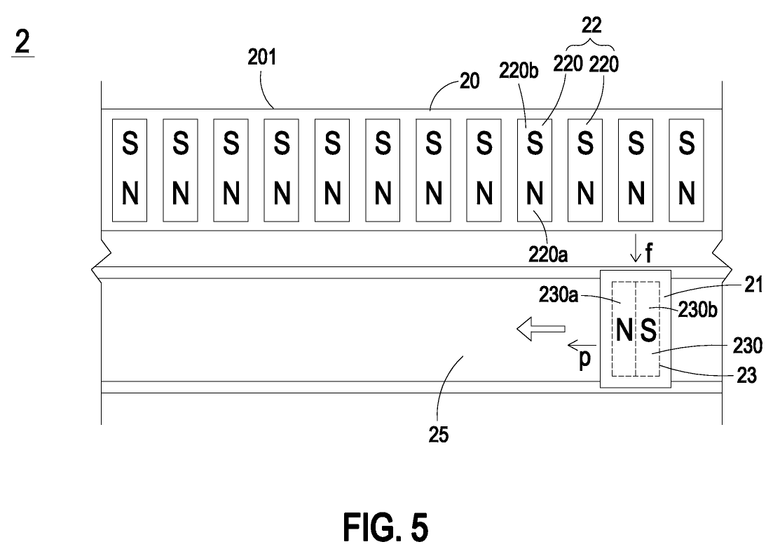

FIG. 5 is a schematic view illustrating a magnetically driving device according to a second preferred embodiment of the present invention. As shown in FIG. 5, the magnetically driving device 2 principally comprises a first supporting member 20, a second supporting member 21, a first magnet set 22 and a second magnet set 23. The second supporting member 21 is disposed beside the first supporting member 20 and movable with respect to the first supporting member 20. The first magnet set 22 is fixed on the first supporting member 20. The first magnet set 22 comprises one or more first magnet units 220. Each first magnet unit 220 of the first magnet set 22 includes a first magnetic pole 220a and a second magnetic pole 220b. The first magnetic pole 220a and the second magnetic pole 220b of the first magnet unit 220 have different polarities. The second magnet set 23 is fixed on the second supporting member 21. The second magnet set 23 comprises one or more second magnet units 230. Each second magnet unit 230 of the second magnet set 23 includes a first magnetic pole 230a and a second magnetic pole 230b. The first magnetic pole 230a and the second magnetic pole 230b of the second magnet unit 230 have different polarities. The magnetization direction p of the first magnetic pole 230a of the second magnet unit 230 is not parallel with the magnetization direction f of the first magnetic pole 220a of the first magnet unit 220. Since like poles repel each other and unlike poles attract each other, the attractive or repulsive force generated between the second magnet units 230 and the first magnet units 220 will drive movement or rotation of the second supporting member 21 with respect to the first supporting member 20.

In this embodiment, the first magnet set 22 comprises multiple first magnet units 220. These first magnet units 220 are connected with or separated from each other as long as the first magnetic poles 220a of the first magnet units 220 are arranged at the same side of the first magnet set 22. The first magnet units 220 are embedded into the first supporting member 20. The first magnet units 220 are arranged on the first supporting member 20 so as to collectively define a linear or crooked region 201. In this embodiment, the first supporting member 20 is plastic article or structured element. Due to the configuration of the first supporting member 20, the first magnet units 220 are stationary. The second magnet unit 230 is fixed on the second supporting member 21. An example of the second supporting member 21 is a carriage, which is disposed on a transportation rail 25. The transportation rail 25 is disposed beside the linear or crooked region 201 of the first supporting member 20 such that the second magnet unit 230 is disposed in the vicinity of the first magnet units 220.

In some embodiments, the first magnetic poles 220a and the second magnetic poles 220b of the first magnet units 220 are N-poles and S-poles, respectively. The first magnetic poles 230a and the second magnetic poles 230b of the second magnet units 230 are N-poles and S-poles, respectively. The first magnetic poles 220a (i.e. N-poles) of the first magnet units 220 are close to the inner surface of the first supporting member 20. The second magnetic poles 220b of the first magnet units 220 (i.e. S-poles) are close to the outer surface of the first supporting member 20. The magnetization direction p of the first magnetic pole 230a of the second magnet unit 230 is not parallel with the magnetization direction f of the first magnetic pole 220a of the first magnet unit 220. For example, the included angle between the magnetization direction p of the first magnetic pole 230a and the magnetization direction f of the first magnetic pole 220a is ranged from 45 to 90 degrees. Since like poles repel each other and unlike poles attract each other, the attractive or repulsive force generated between the second magnet units 230 and the first magnet units 220 will drive movement or rotation of the second supporting member 21 with respect to the first supporting member 20. In other words, when the second magnet units 230 are influenced by the magnetic field (or the magnetic field lines) of one of the first magnet units 220, the second magnet unit 230 is moved forward and then influenced by the magnetic field of an adjacent first magnet unit 120. The second magnet unit 230 is continuously moved forward and then influenced by the magnetic field of the next first magnet unit 220. As a consequence, the second supporting member 21 is continuously moved on the transportation rail 25. In other words, the magnetically driving device of this embodiment can be used for driving a transportation system such as a conveyor.

From the above description, the magnetically driving device of the present invention can be used as a motive power source or an energy source of a driven device. That is, the magnetically driving device can generate motive power or electric energy without resulting in ecological problems.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetically driving device comprising:
a first supporting member;
a second supporting member disposed beside said first supporting member and movable with respect to said first supporting member;
a first magnet set fixed on said first supporting member and including at least one first magnet unit, wherein said first magnet unit has a first magnetic pole and a second magnetic pole of different polarities; and
a second magnet set fixed on said second supporting member and including at least one second magnet unit, wherein said second magnet unit has a first magnetic pole and a second magnetic pole of different polarities,
wherein the magnetization direction of said first magnetic pole of said first magnet unit and the magnetization direction of said first magnetic pole of said second magnet unit are not parallel with each other, so that a magnetic force generated between said first magnet unit and said second magnet unit drives movement of said second supporting member with respect to said first supporting member.

2. The magnetically driving device according to claim 1 wherein said first magnet set includes multiple first magnet units that are connected with or separated from each other, and said first magnetic poles of said first magnet units are arranged at the same side of said first magnet set.

3. The magnetically driving device according to claim 2 wherein said multiple first magnet units are arranged in a stack or in an array.

4. The magnetically driving device according to claim 1 wherein said at least one first magnet unit of said first magnet set is embedded into said first supporting member and defines an annular region.

5. The magnetically driving device according to claim 4 wherein said first supporting member is an annular plastic article or structured element.

6. The magnetically driving device according to claim 4 wherein said second supporting member comprises a rotary member including a shaft portion and at least one rotating arm.

7. The magnetically driving device according to claim 6 wherein said rotary member is enclosed by said annular region of said first supporting member, and the centerline of said shaft portion of said second supporting member and the centerline of said first supporting member are superimposed with each other.

8. The magnetically driving device according to claim 6 wherein said second magnet unit is arranged on a distal part of said rotating arm and in the vicinity of said annular region of said first supporting member such that said second magnet unit is in the vicinity of said first magnet unit.

9. The magnetically driving device according to claim 6 wherein a gear set is connected to said shaft portion.

10. The magnetically driving device according to claim 1 wherein said first magnetic pole and said second magnetic pole of said first magnet unit are respectively N-pole and S-pole, and said first magnetic pole and said second magnetic pole of said second magnet unit are respectively N-pole and S-pole.

11. The magnetically driving device according to claim 1 wherein said first supporting member is a stator and said second supporting member is a rotator.

12. The magnetically driving device according to claim 1 wherein said first supporting member is a rotator and said second supporting member is a stator.

13. The magnetically driving device according to claim 1 wherein said second magnet unit and said first magnet units are coplanar or non-coplanar.

14. The magnetically driving device according to claim 1 further comprising a first conducting wire, a first floating connection element, a second floating connection element, a second conducting wire and a third conducting wire.

15. The magnetically driving device according to claim 14 wherein said first conducting wire is disposed on said second supporting member and arranged between said first magnet set and said second magnet set.

16. The magnetically driving device according to claim 14 wherein both terminals of said first conducting wire are respectively connected to a first terminal of said first floating connection element and a first terminal of said second floating connection element, a second terminal of said first floating connection element and a second terminal of said second floating connection element are respectively connected to said second conducting wire and said third conducting wire in a floating connection manner, and said second conducting wire and said third conducting wire are fixed onto said second supporting member.

17. The magnetically driving device according to claim 16 wherein when said second supporting member is moved with respect to said first supporting member, said first conducting wire cut through magnetic field lines of said first magnet unit generate a current in the first conducting wire, and said current is transmitted out of said magnetically driving device through said first floating connection element, said second floating connection element, said second conducting wire and said third conducting wire.

18. The magnetically driving device according to claim 1 wherein said at least one first magnet unit of said first magnet set is embedded into said first supporting member and defines a linear or crooked region.

19. The magnetically driving device according to claim 18 wherein said second supporting member is a carriage disposed on a transportation rail, and said transportation rail is disposed beside said linear or crooked region of said first supporting member such that the second magnet unit is disposed in the vicinity of said first magnet unit.

20. The magnetically driving device according to claim 1 wherein said second magnet set comprises multiple second magnet units, and said second magnetic pole of a previous second magnet unit and said first magnetic pole of a next second magnet unit are connected with or separated from each other.
